(19) United States
(12) Patent Application Publication
(10) Pub. No.: US 2009/0286125 A1
(43) Pub. Date: Nov. 19, 2009

(54) BI-ELECTRODE SUPPORTED SOLID OXIDE FUEL CELLS HAVING GAS FLOW PLENUM CHANNELS AND METHODS OF MAKING SAME

(75) Inventors: John A. Setlock, Grafton, OH (US); Thomas L. Cable, Olmsted Falls, OH (US); Serene C. Farmer, Sagamore Hills, OH (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: THE UNIVERSITY OF TOLEDO, Toledo, OH (US)

(21) Appl. No.: 12/418,208

(22) Filed: Apr. 3, 2009

Related U.S. Application Data
(60) Provisional application No. 61/072,833, filed on Apr. 3, 2008.

(51) Int. Cl. H01M 8/10; C04B 35/64; B29C 39/00

(52) U.S. Cl. 429/30; 264/104; 264/618; 425/110

(57) ABSTRACT

A solid oxide fuel cell (SOFC) has a porous electrode support structure on both sides of a thin electrolyte layer. The porous electrode supported cell is formed with gas flow plenum channels on an outer surface of the electrode scaffold.

### CROSS-REFERENCE TO RELATED APPLICATIONS AND STATEMENT REGARDING SPONSORED RESEARCH OR DEVELOPMENT

The present invention claims the benefit of the provisional patent application Ser. No. 61/072,833, filed Apr. 3, 2008.

This invention was made with government support under NNC05AA10A. The government has certain rights in this invention.

The invention described herein was made by an employee of the United States Government and may be manufactured and used by or for the Government for Government purposes without the payment of any royalties thereon or therefore.

### FIELD OF THE INVENTION

The present invention relates generally to fuel cells and high power density solid-oxide fuel cells and solid electrolyzers, and method for the fabrication thereof.

### BACKGROUND OF THE INVENTION

There is no admission that the background art disclosed in this section legally constitutes prior art.

Fuel cells consist essentially of two electrodes that are in contact with an electrolyte. In certain fuel cells, the electrolyte can be a water solution of an acid, such as phosphoric acid. In other types of fuel cells, the electrolyte can be a solid material such as a permeable metal oxide through which ions can migrate.

The solid-state electrolytes generally can withstand the higher operating temperatures that correspond to greater specific power production from fuel cells. Fuel cells that use solid electrolytes are called ceramic fuel cells or, more specifically, solid-oxide fuel cells, because the electrolyte is a thin layer of solid metal oxide.

Certain solid-oxide fuel cells employ a thin solid metal-oxide electrolyte through which oxygen ions can diffuse. A porous cathode electrode and a porous anode electrode are created during the fabrication process on opposite sides of the electrolyte.

One type of solid electrolyte fuel cells, SOFCs (Solid Oxide Fuel Cells), has a ceramic membrane. As the H₂ passes through the anode, it splits and reacts with O-ions coming through the membrane, to form water and electrons. The electrons are conducted through an external circuit toward the oppositely charged cathode. At the cathode, the electrons combine with oxygen to form O-ions which are then conducted through the ceramic electrolyte to the anode.

In general, solid oxide fuel cells (SOFC) have a planar cell geometry with an anode supported cell design (ASC) with metal interconnects. Among the major challenges of the ASC technology, various challenges relate to the fabrication and the reliability of the SOFC, particularly in regard to the stacks of cells that make up the SOFC. In these planar cell geometry ASC design SOFCs, the anode/electrolyte bi-layer is sintered as a unit, followed by application of a thin cathode, usually 25-50 um thick, which is then fired at a lower temperature.

In particular, industry is experiencing a number of problems with the ASC design. These problems include, but are not limited to:

1) shrinkage matching of the thick NiO—YSZ cermet anode and the thin YSZ electrolyte during the sintering stage, to temperatures as high as 1550° C.;

2) as the NiO in the anode is reduced to nickel metal there is a volume change that can generate stresses within the anode and cause fracture and failure of the thin YSZ electrolyte;

3) the anode is sensitive to leaks of oxygen which can cause oxidation of the Ni metal to Ni-oxide resulting in a sudden expansion of the anode and failure of the cell;

4) to provide enough strength, the anodes must be made thick, which can lead to diffusion problems in the anode (which works against achieving high fuel utilization rates that are required for commercial applications);

5) the cells are fragile and cannot tolerate the high compressive loading that is required for the compression type seals that are used with the ASC stacking technology (which has required some manufacturers to install additional metal sealing plates), called cassettes, which add to overall complexity and general materials challenges; and,

6) the cathode and electrolyte/anode bi-layers must be fired simultaneously up to 1,250° C. so as to bond the cathode to the electrolyte, a temperature approximately 400° C. higher than the fuel cell's operating temperature, which can result in significant chemical reactivity during fabrication, thus limiting the use of potentially more active and better performing cathode compositions.

The co-pending Cable et al. US2007/0065701 discloses a method of fabricating bi-electrode supported solid oxide fuel cells that overcomes many of the above described problems by using a freeze casting process which creates microchannels through the electrodes with graded porosity. For some applications, which only require low gas flow through the SOFC, the microchannels can be adequate and allow the required flows without generating large back pressures.

However, for higher power demands and for relatively large cells, significantly higher rates of gas flow may be required through the SOFC than can be accommodated through the microchannels alone.

Therefore, there is a need for a SOFC that will meet such higher power demands and that will be effective in larger cells. Also, there is a particular need for a SOFC that will provide significantly higher rates of gas flow through the SOFC.

There is now described herein further improvements and methods for making SOFCs that meet the industry's needs.

### SUMMARY OF THE INVENTION

In one aspect, there is provided methods for making a new solid oxide fuel cell (SOFC) having a porous electrode support structure on both sides of a thin electrolyte layer.

In a broad aspect, there is provided herein a bi-electrode supported solid oxide fuel cell (BSC) structure having a plurality of gas flow plenum channels incorporated into at least an outer surface or within one or more porous electrode scaffolds.

In another broad aspect, there is provided herein a bi-electrode supported solid oxide fuel cell having a monolithic framework that includes: a first electrode scaffold, a second electrode scaffold, and an electrolyte layer disposed between the first and the second electrode scaffolds. In certain embodiments, the first electrode scaffold and the second electrode scaffold each has a plurality of graded pores that are oriented more or less perpendicularly to the electrolyte layer. Further, in certain embodiments, each electrode scaffold has an outermost exposed surface where at least one of the first and second electrode scaffolds have a plurality of gas flow plenum channels formed in the outer surface thereof, and continuing to some depth within the electrode.

In certain embodiments, the gas flow plenum channels are configured to form more than one pattern on the outer surface or within the electrode scaffold.

In certain embodiments, the first and second electrode scaffolds have essentially the same thickness about the thin electrolyte layer. In another broad aspect, and depending on specific end-use applications, one electrode scaffold can have a greater thickness in order to increase gas flow, heat conduction, and the like.

In certain embodiments, the gas flow channels are formed in both a cathode “air” electrode scaffold and an anode “fuel” electrode scaffold. In certain other embodiments, the gas flow channels are formed in only one of a cathode “air” electrode scaffold or an anode “fuel” electrode scaffold.

In another broad aspect, the BSC can be operated “reversibly” or in “electrolysis” where the gas flow channels are formed in both the anode “oxygen” electrode scaffold and the cathode or “H₂/H₂O” electrode scaffold. In certain other embodiments, the gas flow channels are formed in only one of an anode “oxygen” electrode scaffold or a cathode “H₂/H₂O” or “CO/CO₂” electrode scaffold.

In another broad aspect, provided herein are methods for fabricating gas flow plenum channels in an electrode scaffold. In certain non-limiting examples, the gas flow plenum channels are created while the electrode scaffold is in an unfired state.

In another broad aspect, the method further includes providing interconnect layers adjacent to the electrode scaffold and forming gas flow plenum channels on the interconnect layer prior to positioning the interconnect layers adjacent to the electrode scaffold.

Various objects and advantages of this invention will become apparent to those skilled in the art from the following detailed description of the preferred embodiment, when read in light of the accompanying drawings.

### BRIEF DESCRIPTION OF THE DRAWINGS

The patent or application file contains at least one drawing executed in color. Copies of this patent or patent application publication with color drawings will be provided by the Office upon request and payment of the necessary fee.

The structure, operation, and advantages of the present invention will become apparent upon consideration of the description herein below taken in conjunction with the accompanying FIGURES. The FIGURES are intended to be illustrative, not limiting. Certain elements in some of the FIGURES may be omitted, or illustrated not-to-scale, for illustrative clarity. The cross-sectional views may be in the form of “slices,” or “near-sighted” cross-sectional views, omitting certain background lines which would otherwise be visible in a “true” cross-sectional view, for illustrative clarity.

Elements of the FIGURES can be numbered such that similar (including identical) elements may be referred to with similar numbers in a single FIGURE. For example, each of a plurality of elements collectively referred to as 10 may be referred to individually as 10a, 10b, 10c, etc. Or, related but modified elements may have the same number but are distinguished by primes. For example, 10, 10′, and 10″ are three different elements which are similar or related in some way, but have significant modifications. Such relationships, if any, between similar elements in the same or different figures will become apparent throughout the specification, including, if applicable, in the claims and abstract.

FIG. 1 is a schematic perspective view of the electrode scaffolds and electrolyte layer of a single monolithic bi-electrode supported cell showing gas flow plenum channels in the electrode scaffold.

FIG. 2 is a schematic perspective view of a single symmetrical bi-electrode supported cell, with a thin interconnect at the top and bottom, to make a single “Repeat Unit” which is the building block for a X-flow stack of cells.

FIG. 3 is a schematic perspective view of a trilayer BSC structure.

FIG. 4A is an SEM photograph showing a cross-section of a single “repeat unit” of a bi-electrode supported cell (BSC) structure.

FIG. 4B is an SEM photograph showing a cross-section of a trilayer “repeat unit” of a bi-electrode supported cell (BSC) structure.

FIG. 5 is a schematic illustration of a portion of a bi-electrode supported cell (BSC) structure, showing a reservoir area adjacent to gas flow plenum channels in an electrode.

FIG. 6 is an SEM photograph showing gas flow plenum channels in an electrode scaffold. The FIG. 6 shows the difference in scale of the narrow, microscopic scale channels generated naturally during the freeze cast process, and the large V-channels added later by some mechanical process.

FIG. 7 is an SEM photograph showing a fracture sample, where the smallest pores are at the electrode and the largest pores are at the top of the support scaffold.

FIG. 8 is an SEM photograph of a trilayer BSC showing that the pores have their smaller opening adjacent to the electrolyte layer 12.

FIG. 9 is a graph comparing the gas flow rates as a function of gas pressure for three types of electrodes; electrodes with porous channels generated with standard pore former materials that burn out during heat treatment; the freeze cast channels; and the freeze cast channels with the addition of V-channels as shown in FIG. 6.

FIGS. 10A and 11B are SEM photographs of a top of a bi-electrode supported cell (BSC) structure, showing microchannels formed in an asymmetrical pattern or array, producing electrode scaffold using a non-contact freeze casting process.

FIGS. 11A, 11B and 11C are schematic illustrations of freeze-casting systems.

FIG. 12 is a schematic illustration of a freeze-cast system using a fugitive material process.

FIG. 13 is a schematic illustration of a freeze-cast system using a mesh fugitive material process.

FIG. 14 is a schematic illustration of a freeze-cast system using a process to apply a fugitive material.

FIG. 15 is a schematic illustration of a preform useful in a freeze-cast system using a fugitive material process.

FIG. 16 is a schematic illustration of a freeze-cast system using a stamping process.

FIG. 17 is a schematic illustration of a freeze-cast system using a groove forming process.

FIG. 18 is a schematic illustration of a freeze-cast system using an ablation and/or etching process.

FIG. 19 is a schematic illustration of a freeze-cast system using a milling process.

FIG. 20 is a schematic illustration of a freeze-cast system using an extrusion process.

### DETAILED DESCRIPTION OF THE PREFERRED EMBODIMENT(S)

In a broad aspect, there is provided herein a solid oxide fuel cell (SOFC) and method for fabricating the same which overcomes the aforementioned problems with higher power requirements and the need for larger fuel cells.

“ASC” refers to an anode supported fuel cell design where only the thick anode electrode provides the support for a thin electrolyte.

“BSC” refers to a bi-electrode supported fuel cell structure, or design, described herein that has both electrodes supporting a thin electrolyte.

“Aqueous” refers to the liquid component, such as water or organic solvent, of a slurry material.

“Fuel cell” refers to a device comprising an electrolyte that is disposed between two electrodes, one of which reacts with a fuel, the other with an oxidizer.

“Fuel cell stack” refers to a stack of individual fuel cells that are electrically connected to one another in parallel or series to provide electric power at, respectively, low voltage or high voltage.

“Monolith” or “monolithic” refers to a unitary ceramic object comprised of sintered solid oxide material.

“Scaffold” is a graded pore structure that acts as a support for the dense electrolyte, once subjected to sintering, is a porous ceramic that can be treated with appropriate metal solutions and heat treated, whereby the scaffold has imparted to it either anodic or cathodic catalytically active properties.

“Symmetrical” refers to the like thicknesses and microstructure of the electrodes and the electrode scaffolds that support the thin intervening electrolyte layer.

“SOFC” refers to a solid oxide fuel cell.

The SOFC cell and stack “bi-electrode supported fuel cell” (BSC) design described herein has an improved reliability, while having less weight, than an anode supported cell (ASC) and stack design.

The SOFC sell and stack BSC design described herein also provides more intimate gas and fuel flow to the electrode/electrolyte interface by having gas flow plenum channels formed in the electrode scaffolds; rather than in the metal interconnects as in the ASC design. In certain non-limiting examples, the gas channels can be about 750 microns above the electrode/electrolyte interface.

The SOFC cell and stack BSC design described herein also replaces the metal interconnects, sometimes 2,500 microns thick, with a thin ceramic interconnect of 50-60 microns, dramatically reducing the weight and volume of each “repeat unit” of the bi-electrode supported cell (BSC) structure.

In one aspect, there is provided herein a bi-electrode supported solid oxide fuel cell comprising: i) a first electrode scaffold, ii) a second electrode scaffold, and iii) an electrolyte layer disposed between the first and the second electrode scaffolds; where at least one of the first and second electrode scaffolds includes a plurality of gas flow plenum channels.

In certain embodiments, the first and second electrode scaffold each has an outer surface; and wherein least one of the first and second electrode scaffolds has the plurality of gas flow plenum channels formed in the outer surface thereof.

In certain embodiments, the plurality of gas flow plenum channels are at least partially within an interior of one or more of first and second electrode scaffolds.

In certain embodiments, the first electrode scaffold and the second electrode scaffold are porous.

In certain embodiments, at least one of the first and second electrode scaffolds has a plurality of pores that are oriented generally less perpendicularly with respect to the electrolyte layer,

In certain embodiments, at least some pores are graded in size such that smallest ends of the pores are adjacent the electrolyte layer.

In certain embodiments, the gas flow plenum channels are configured to form more than one pattern on the outer surfaces of the electrode scaffold.

In certain embodiments, the gas flow plenum channels have a depth of between about 10% and about 100% of the thickness of the electrode scaffold.

In certain embodiments, the first and second electrode scaffolds have essentially the same thickness.

In certain embodiments, at least some of the graded pores have a small pore end having dimensions between about 0.2 um and about 5 um, and preferably between about 0.2 um and about 1 um, and having a large pore end having dimensions between about 15 um and about 125 um, and preferably of between about 15 um and about 75 um.

In certain embodiments, the electrode scaffolds are comprised of solid ceramic materials.

In certain embodiments, the first electrode scaffold and the second electrode scaffold each has an electrically conductive ceramic coating deposited on the outer surface.

In certain embodiments, the coatings are configured to form interconnects to at least one other bi-electrode supported solid oxide fuel cell in a stack of such cells.

In certain embodiments, the ceramic interconnects are about 30 microns in thickness.

In certain embodiments, the electrode scaffolds are comprised of ionic conductor materials.

In certain embodiments, the ionic conductors are either protons or oxygen ions.

In certain embodiments, the protonic conductors comprise one or more of: doped barium cerate (BaCeO₃), doped strontium cerate (SrCeO₃), doped barium zirconate (BaZrO₃), strontium zirconate (SrZrO₃), and mixtures thereof.

In certain embodiments, the oxygen ion conductors are comprised of a fluorite-like crystal structure.

In certain embodiments, the oxygen ion conductors are comprised of one or more of doped metal oxides.

In certain embodiments, the doped metal oxides include zirconium, cerium, bismuth, hafnium, thorium, indium or uranium oxides. In certain embodiments, the doped metal oxides comprise doped zirconia (ZrO₂) or doped ceria (CeO₂).

In certain embodiments, the oxide ion conductors comprise one or more of: yttria stabilized zirconia (YSZ or 8YSZ), partially stabilized zirconia (3YSZ), scandia stabilized zirconia (ScSZ), gadolinium doped ceria (GDC), samarium doped ceria (SDC), yttrium doped ceria (YDC), and a perovskite oxide conductor, strontium and magnesium-doped lanthanum gallate, referred to as LSGM (LaSrGaMgO₃).

In certain embodiments, the electrode scaffolds and the electrolyte layer are comprised of ceramic materials that have essentially the same coefficients of thermal expansion.

In certain embodiments, the fuel cell further includes electrically conductive interconnect layers, and edge sealant sets that are comprised of the same ceramic materials as the electrode scaffolds and the electrolyte layer.

In certain embodiments, the gas flow plenum channels are formed in both a cathode or an “oxygen” electrode scaffold and an anode or “fuel” electrode scaffold.

In certain embodiments, the gas flow plenum channels are formed in only one of a cathode “air” electrode scaffold or an anode “fuel” electrode scaffold.

In certain embodiments, the gas flow plenum channels form a pattern on an outer surface of at least one electrode scaffold.

In another aspect, there is provided herein a method for fabricating an electrode scaffold having a plurality of gas flow plenum channels, comprising the step of creating a plurality of gas flow plenum channels in an electrode scaffold while the electrode scaffold is in an unfired state.

In certain embodiments, the gas flow plenum channels are formed by removing fugitive materials from the electrode scaffold.

In certain embodiments, the fugitive materials are removed during a high temperature sintering stage.

In certain embodiments, the gas flow plenum channels are created by applying one or more rows of a fugitive material on at least one outer surface of the electrode scaffold.

In another aspect, there is provided herein a method for fabricating an electrode scaffold having a plurality of gas flow plenum channels, comprising the step of casting a ceramic slurry material, and freezing the ceramic slurry material to form the electrode scaffold.

In certain embodiments, the freezing forms a complex pore structure in the electrode scaffold without a need for thermally fugitive pore former materials present in the ceramic slurry material.

In certain embodiments, the method includes filling a preform with the ceramic slurry material, freezing the ceramic slurry material to form the electrode scaffold, and thereafter removing the perform mold from the formed electrode scaffold.

In certain embodiments, the ceramic slurry material freezes in a directional manner so as to cause formation of crystals in the freezing ceramic slurry material, the crystals giving rise to a graded pore structures within the electrode scaffold.

In certain embodiments, the ceramic material is frozen by removing heat from a top surface of the ceramic slurry material such that the ceramic slurry material freezes in a top-to-bottom directional manner.

In certain embodiments, the ceramic material is frozen by removing heat from a bottom surface of the ceramic slurry material such that the ceramic slurry material freezes in a bottom-to-top directional manner.

In certain embodiments, the ceramic material is frozen by removing heat from a top surface and a bottom surface of the ceramic slurry material such that the ceramic slurry material freezes in an outside-to-inside directional manner.

In certain embodiments, the gas flow plenum channels are formed using a mechanical imprinting process.

In certain embodiments, the gas flow plenum channels are formed by pressing a patterned material into an outer surface of the electrode scaffold.

In certain embodiments, the method includes pressing a stamp or die with a plurality of spaced blades into an outer surface of the electrode scaffold, freeze casting to form the electrode scaffold, and freeze drying the formed electrode scaffold.

In certain embodiments, the method includes casting a ceramic slurry material onto a grooved plate; non-contact freezing the ceramic slurry material to form the electrode scaffold, and thereafter, freeze drying the formed electrode scaffold on the grooved plate.

In certain embodiments, the gas flow plenum channels are created by etching a plurality of gas flow plenum channels onto an outer surface of the electrode scaffold.

In certain embodiments, the gas flow plenum channels are created by machining a plurality of gas flow plenum channels onto an outer surface of the electrode scaffold, either in a vertical or a horizontal direction.

In certain embodiments, the method further includes providing interconnect layers adjacent to the electrode scaffold and forming gas flow plenum channels on the interconnect layer prior to positioning the interconnect layers adjacent to the electrode scaffold.

In another aspect, there is provided herein a non-contact freeze casting system for forming an electrode scaffold, wherein a ceramic slurry material freezes in a directional manner so as to cause formation of crystals in the freezing ceramic slurry material, the crystals giving rise to a pore structures within the electrode scaffold, the method comprising: a casting bed across which a carrier material is dispensed; a reservoir configured for dispensing a ceramic slurry material onto the carrier material; at least one freezing plate positioned in a spaced apart relationship to the casting bed; and a system for advancing the ceramic slurry material and film past the freezing plate.

In certain embodiments, the system further includes a freeze drying chamber wherein a vacuum causes the crystals to evaporate so as to leave the graded pores within the electrode scaffold.

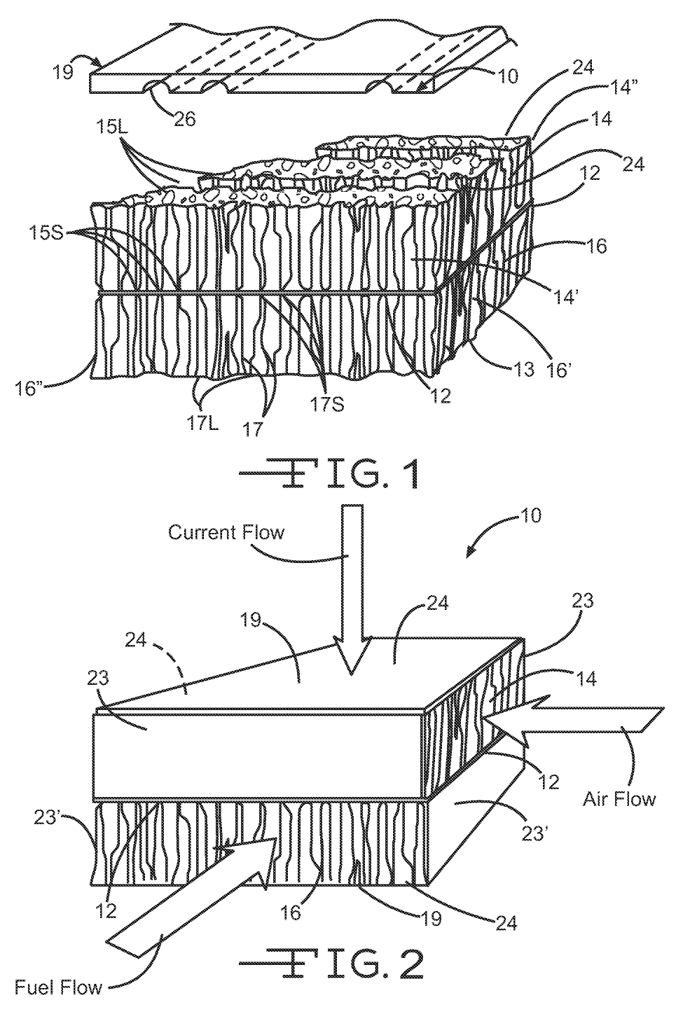

Referring now in particular to FIGS. 1 and 2, there is shown therein one embodiment of a bi-electrode supported fuel cell (BSC) structure 10. FIG. 3 shows a bi-electrode supported cell (BSC) structure having multiple “repeat units” of stacks. The bi-electrode supported cell (BSC) structure 10 can include, as main operational elements, a first electrode scaffold 14, a second electrode scaffold 16, and a thin electrolyte layer 12 that is monolithically disposed between the first and the second electrode scaffolds 14, 16. In certain embodiments, the thin electrolyte layer 12 can have a thickness of between about 1 um and about 250 um, and in certain embodiments, between about 1 um and about 25 um.

The first electrode scaffold 14 and the second electrode scaffold 16 each has essentially the same thickness as the other; for example, in certain embodiments, each has a thickness in the range of about 10 um to about 2000 um; and in certain embodiments, about 100 um to about 750 um.

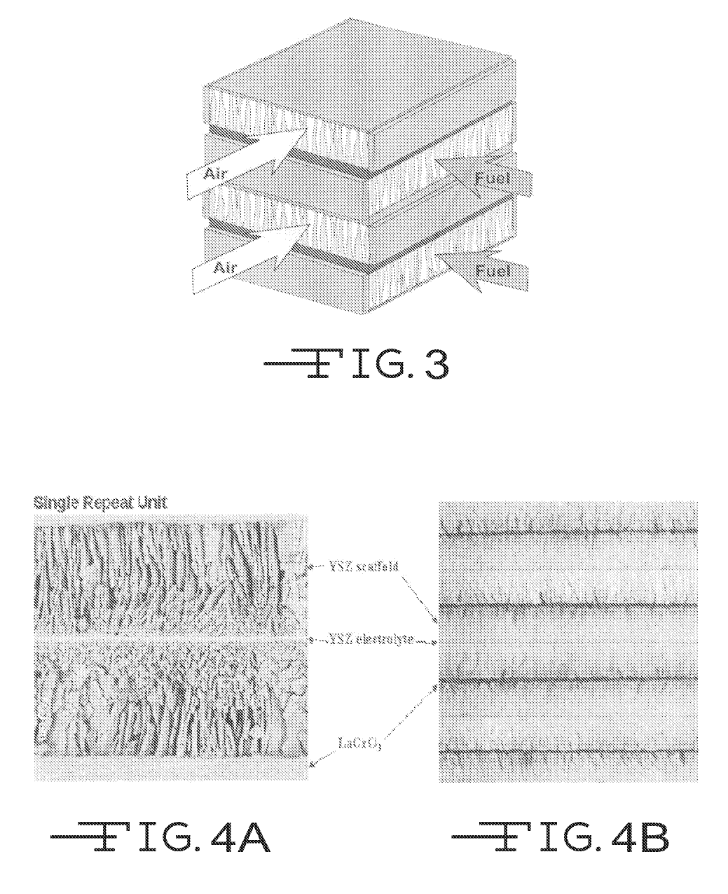

The two outermost exposed surfaces 11 and 13, respectively, of the first electrode scaffold 14 and the second electrode scaffold 16 each also has a thin electrically conductive ceramic interconnect layer 19 deposited thereon. The interconnect layer 19 acts to connect the adjacent cells (see, for example, FIG. 3 and FIG. 4B) in a stack of such cells. In certain embodiments, the interconnect layer 19 can be about 2 microns to about 1000 microns in thickness; and, in certain embodiments, about 10 to about 50 microns.

It is to be understood, that in certain embodiments, one or more passageways 26 can be formed in the interconnect layer 19, as shown in FIG. 1. In certain embodiments, the height of one side of the interconnect layer 19 can be about 10 to 1000 microns such that the passageways 26 can be formed therein.

The bi-electrode supported cell (BSC) structure 10 can also include ceramic sealant layers 23 and 23′. The ceramic sealant layers 23 cover the two opposing edges 14′, 14″ (see FIG. 1) of the first electrode scaffold 14, and the ceramic sealant layers 23′ cover the two opposing edges 16′, 16″ of the second electrode scaffold 16.

As best seen in FIG. 2, the non-porous electrolyte layer 12 is disposed between the porous first electrode scaffold 14 and the porous second electrode scaffold 16. That is, the first electrode scaffold 14 and the second electrode scaffold 16 each comprises a plurality of graded micro-channel pores, 15,17 respectively, that are oriented more or less perpendicular to the thin electrolyte layer 12. The micro-channel pores 15 of the first electrode scaffold 14, and the micro-channel pores 17 of the second electrode scaffold 16 are graded in size such that the smallest ends 15S, 17S of the sets of micro-channel pores 15 and 17 are adjacent the electrolyte layer 12, and the largest ends 15L, 17L are disposed most distal from the electrolyte layer. The micro-channel pores 15, 17 within each electrode scaffold 14, 16 are generally oriented (more perpendicularly than horizontally) in a direction toward the thin electrolyte layer 12.

In certain embodiments, the small ends of the micro-channel pores have dimensions that are between about 0.2 um and about 5 um; and, in certain embodiments, between about 0.2 and about 1.0 um. Also, in certain embodiments, the large ends of the micro-channel pores have dimensions that are between about 15 um and about 125 um; and, in certain embodiments, between about 15 um and about 75 um.

It should be understood, however, that the BSC structure 10 can be formed where the micro-channel pore dimensions provided herein can be altered so that the BSC structure is particularly useful and efficient in its end use application. It is also within the contemplated scope of the disclosure herein that the dimensions of the electrodes, gas flow plenum channels, micro-channel pores, and the like can be configured with dimensions that allow the BSC structure 10 to be useful in micro-fuel cell markets, where there would be smaller dimensions rather than larger dimensions.

FIGS. 4A and 4B are SEM photographs where FIG. 4A shows a SEM cross-section of a single “repeat unit” of a BSC structure, and FIG. 4B shows a SEM cross-section of a bi-electrode supported cell (BSC) structure having three (3) “repeat units.” The FIGS. 4A and 4B show the scaffold, the electrolyte and the interconnect layer. For example, a thin LaCrO₃ layer can be the interconnect layer 19 since LaCrO₃ is ceramic, but is also a pure electronic conductor. Also, as shown in FIGS. 4A and 4B, the interconnect layer 19 is thin (black layer) where it is only about 50-60 microns thick.

Referring again to FIGS. 1 and 2, the first electrode scaffold 14 and the second electrode scaffold 16, as well as the electrolyte layer 12, are made of essentially conducting materials; and in particular, ionic conductors. In certain embodiments, the conductor materials are selected from a general class of solid ceramic materials that include ionic conductors of either protons or, in certain embodiments, oxygen ions.

In other applications, the electrode scaffolds 14, 16 are made from a class of materials know as mixed ionic electronic conductors (MIEC). Non-limiting examples of MIEC materials include, for example, doped CeO₂, doped LaCoO₃, doped LaFeO₃, and combinations thereof. Also, in certain embodiments, the scaffolds can include a coating of thin films on the scaffolds.

In one non-limiting example of protonic conductors, the general class of materials can be, for example, doped barium cerate (BaCeO₃) or doped strontium cerate (SrCeO₃), doped barium zirconate (BaZrO₃) or strontium zirconate (SrZrO₃) and mixtures of these. It is to be understood that BSC structure 10 is not limited to these materials. Rather, it is desired that the useful materials be stable in both the reducing and the oxidizing environments where the cell is exposed during fabrication and use. In the case of oxygen ion conductors, many of which have the fluorite like crystal structure, the general class of materials can be, for example, doped zirconia (ZrO₂), doped ceria (CeO₂) and other doped oxides of metals such as bismuth, hafnium, thorium, indium or uranium. In certain embodiments, oxide ion conductors of materials such as yttria stabilized zirconia (YSZ or 8YSZ), partially stabilized zirconia such as 3YSZ, scandia stabilized zirconia (ScSZ), gadolinium doped ceria (GDC) or other commonly doped cerias such as samarium or yttrium (SDC or YDC), and a perovskite oxide conductor, strontium and magnesium-doped lanthanum gallate, referred to as LSGM (LaSrGaMgO₃) can be effectively used.

In certain embodiments, the BSC structure 10 can be considered a single monolithic ceramic framework wherein the electrode scaffolds 14, 16, electrolyte layer 12, electrically conductive interconnect layers 19, and edge sealant sets 23, 23′ are made of ceramic materials that have essentially the same coefficients of thermal expansion. In one embodiment, for example, the main active fuel cell components are the two electrode scaffolds 14, 16 and the thin electrolyte layer 12, all of which are made of essentially one material.

For example, the bi-electrode supported cell (BSC) structure in FIG. 4A is comprised of YSZ. It is to be understood that the bi-electrode supported cell (BSC) structure can be made with materials having the same coefficient of thermal expansion which serves to minimize interfacial stresses during high temperature processing such as sintering, as well as the potential for such stresses as might otherwise arise during use of the fuel cell.

In certain embodiments, the electrode scaffolds 14, 16 are more or less symmetrical, having essentially the same thickness about the thin electrolyte layer 12. The two electrode scaffolds 14, 16 provide balanced stresses on each side of the thin electrolyte layer 12 during both the fabrication and the use of the bi-electrode supported cell (BSC) structure fuel cell or fuel cell stack.

After undergoing a sintering process, the bi-electrode supported cell (BSC) structure 10 is a monolithic framework. The electrode scaffolds 14, 16 then undergo a treatment with metal salts or oxides and heat to provide the electrode scaffolds 14, 16 with the desired catalytically active anode or cathode properties.

In one embodiment, in order to reduce weight and volume of the bi-electrode supported cell (BSC) structure 10, the BSC structure 10 has no interconnect layer; rather there are gas passageways in the electrode.

As shown in FIG. 2, the electrode scaffolds 14, 16 can include a plurality of gas flow plenum channels 24 that are formed in the outer surfaces 14a and 16a in the electrodes 14, 16, respectively. In certain embodiments, the gas flow plenum channels 24 can have a depth of about 300 to about 500 microns and which depends on the thickness of the scaffold and the required flow rate of the gases.

In order for the bi-electrode supported cell (BSC) structure 10 to generate the same power per cell, the bi-electrode supported cell (BSC) structure 10 must maintain the similar flow rates in the bi-electrode supported cell gas flow plenum channels 24 as that is generally achieved in solid oxide fuel cells that only have channels in the metal interconnects. The gas flow plenum channels 24 provide high air flows for cooling, such that, in certain embodiments, the bi-electrode supported cell (BSC) structure 10 can have lower internal resistance which, in turn, means that the bi-electrode supported cell (BSC) structure 10 can generate more power while consuming the same hydrogen and oxygen.

The bi-electrode supported cell (BSC) structure 10 overcomes the particular problems that have previously occurred on the “air” side of the ASC structures where the ASC cell had difficulty in removing heat (as compared to fuel cells having metal interconnects which are better heat conductors relative to the ceramic materials).

In certain embodiments, there is a requirement that the air flow be greatly increased; for example, increased 3-fold (6 stoichs) to values above those of a standard commercial fuel cell, which generally use 2 stoichs air flow; meaning that a flow of air 2× is required to deliver enough oxygen to consume 100% of the fuel.

In order to maintain a controlled and reasonable back pressure on each cell in a stack of the bi-electrode supported cell (BSC) structure 10, the bi-electrode supported cell (BSC) structure 10 includes the gas flow plenum channels 24 which enhance the flow and reduce back pressure, particularly on the “air” flow electrode side.

It is to be understood that the gas flow plenum channels 24 can form more than one pattern on the outer surfaces 14a, 16a, of the electrode scaffolds 14,16, respectively, as will be seen by the following explanation of the several methods for forming gas flow plenum channels 24 in the electrode scaffolds 14,16.

The present invention is further defined in the following Examples, in which all parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. All publications, including patents and non-patent literature, referred to in this specification are expressly incorporated by reference herein.

### Example I

### Fabrication of Symmetrical Bi-Electrode Supported Cell (Bsc) Structures

One process of making symmetrical bi-electrode supported solid oxide fuel (BSC) cells can include a high temperature sintering step, which is followed by the process steps of converting each of the electrode scaffolds into active electrodes by imparting catalytic activity to them by solution and thermal treatment means which include separate steps for the anode and the cathode.

In certain embodiments, the following method is used to fabricate a single, monolithic, symmetrical, solid-state, bi-electrode supported fuel cell comprising a cathode, an anode and an intervening region of solid electrolyte where at least the electrode includes gas flow plenum channels on one or more outer surfaces.

After forming the electrode scaffolds 14, 16, a thin coating 12′ is applied to the outer surfaces 14a, 16b of the electrodes. It is to be noted that the thin coating 12′ becomes the electrolyte 12 after undergoing a sintering process, as described herein.

In certain embodiments, the coating can be an ink-type material that is screen printed or air brushed/sprayed-on on the outer surfaces 14a, 16a (i.e., the sides having the smaller pore openings 15s, 17s. The coating 12′ can be between about 20 and about 40 um thick in the ‘green’ state which, after sintering, results in an electrolyte layer having a total thickness of between about 15 um and about 20 um. In certain embodiments, the coating 12′ can be comprised of a YSZ ink formulation that also includes an ethyl cellulose binder when the terpineol/xylene type solvents are used, so as to impart flexibility prior to sintering. Also, in certain embodiments, the YSZ ink can contain a polymeric compound to impart flexibility prior to sintering; in the water based system an acrylic latex binder is used, and in the terpineol/xylene system an ethyl cellulose binder can be used.

During the fabrication of the monolith bi-electrode supported cell (BSC) structure 10, the electrode scaffolds 14, 16, having respective coatings 12′ thereon, are brought together, or mated, so that the respective coated surfaces 12′ make intimate contact. Slight pressure might be applied to remove intervening bubbles. The respective coatings 12′ will, during and subsequent to sintering, become merged into the single, thin, nonporous electrolyte 12 which is disposed between the electrode scaffolds 14, 16. It is to be noted that the electrode scaffolds 14, 16 provide a graded porosity within a single, monolithic bi-electrode supported cell (BSC) structure 10; that is, the large pores 15L, 17L are most distal from the coating 12′.

The sintering process, which takes place upon completion of the assembly of the cell, causes the component ceramic particles to become fused into a single piece that is an integral, unified piece of ceramic that is solid except for the intended pores 15, 17. Polymeric components that had been part of the aqueous ceramic slurry material 40 and coating formulations 12′ are burned away during the sintering process.

It is to be understood that there are different cell fabrication methods and/or sequences that can be used. For instance, the two unsintered electrode scaffolds 14, 16 can be placed together while the ink of the layers 12′ is not completely dry. As should be apparent to those skilled in the art, it is desirable that no bubbles or gaps exist between the two mated electrodes 14, 16, which result in flaws in the thin electrolyte layer 12′.

In certain embodiments, prior to sintering, the two unsintered electrode scaffolds 14, 16 may be coated with a thin film of metal oxide for the purpose of improving the bonding of electrocatalytic materials, or to impart electronic conductivity and to reduce interfacial resistance at the electrode/electrolyte interface, by depositing a thin coating of a ceramic material upon each of the first and second electrode scaffolds 14, 16.

Also, in certain embodiments, the two scaffolds 14, 16 may be fabricated using a slip formulation that is “doped” or modified to include a metal oxide for the purpose of improving the bonding of electrocatalytic materials, or to impart electronic conductivity and to reduce interfacial resistance at the electrode/electrolyte interface, by increasing the ionic and electronic conductivity into the region of the scaffold near the electrolyte.

Also, in certain embodiments, and in the fabrication of a “repeat unit”, but prior to sintering, the creation of a symmetrical bi-electrode supported solid oxide fuel cell requires the additional steps of depositing a thin coating 19 of an electrically conductive ceramic material upon the two outermost exposed surfaces 14a, 16a (i.e., the surfaces having the coarse pores 15L, 17L) of each of the first and second electrode scaffolds 14, 16. Subsequent to the sintering process, the coatings 19 become thin layers of electrically conductive ceramic which serve as electrical interconnects 19 with adjacent cells. In certain non-limiting examples, the coatings 19 can be made of such materials as doped-LaCrO₃. The creation of the layers 19 involves deposition of a slurry of the desired ceramic material with a polymeric compound that gets burned off during sintering, providing electrically conductive interconnect layers 19 that have a coefficient of thermal expansion that is essentially the same as that of the other materials in the present symmetric BSC. In certain embodiments, the thickness of the final interconnect layers 19 is in the range of about 2 um to about 200 um, and in certain preferred embodiments, in the range of about 5 um to about 25 um. Also, in certain embodiments, common dopants can be, but are not limited to Ca, Sr, Y, Co, Mg, Al, and other less common dopants might include Group IA and 3A metal oxides, noble metals and the like.

Also, it is to be understood that the opposing edges 14′ and 14″ of the electrode scaffold 14 and the opposing edges 16′, 16″ of the electrode scaffold 16 are coated with, or impregnated with, ceramic sealant layers 23, 23′ so as to provide dense, hermetic seals for the creation of flow channels for fuel and air (as indicated by the “Air Flow” and “Fuel Flow” arrows in FIGS. 2 and 3) through the respective porous electrode scaffolds 14, 16. It is to be understood that, subsequent to sintering, the respective porous electrode scaffolds 14, 16 are treated by solution and thermal treatment means with appropriate solutions of metal salts so as to impart anodic and cathodic catalytic activity to the respective electrode scaffolds.

The ceramic sealant layers 23, 23′ can be made of a glass or ceramic or a combination of the two, that is not electrically conductive and which has a coefficient of thermal expansion that is essentially the same as that of the material used in the creation of the electrode scaffolds 14, 16, the electrolyte layer 12 and, in the case of a stack of cells, the layers of the thin interconnect layers 19.

The entire bi-electrode supported cell (BSC) structure 10 is then dried, or at least substantially dried, before being placed in a sintering furnace where it is gradually heated to 1350° to 1550° C. for several hours.

Referring now to FIG. 5, the bi-electrode supported cell (BSC) structure 10 can include a central plenum, or reservoir area, 29 where the pressure equilibrates before entering the gas plenum channels 24. The shapes and/or depths of the gas plenum channels can be constructed to meet particular applications. For example, electrolysis will most likely require very slow flow rates, whereas SOFC will require very high flow rates and the shape of the gas plenum channels will also affect the rate the heat is removed. In certain embodiments, the bi-electrode supported solid oxide fuel cell can include gas flow plenum channels that have a depth of between about 10% and about 100% of the thickness of one or both electrode scaffolds.

The reservoir area 29 allows for the delivery of the same gas flow down each of the gas flow plenum channels 24 and throughout the freeze cast micro-channel pores 15, 17 (micro-channel pores not shown in FIG. 5).

FIG. 5 shows the increased cell area and gas flows at a point where the gas flow plenum channels meet a freeze cast layer. That is, the reservoir 29 provides an area of higher pressure before the gas is fed into the individual gas flow plenum channels 24 and micro-channel pores 15, 17 (i.e., freeze cast pore channels).

In addition, the electrodes 14, 16 can be formed where the gas flow plenum channels have different types of planar designs, such as a cross-flow, a co-flow, and counter flow configuration, as further explained herein. Each gas flow plenum channel configuration provides a different temperature gradient, which then changes how the gases would flow. The gas flow can thus be used to control the “hot spots”, which means the channel design can be specific to the stack application and/or to the operating conditions (for example, high power-high heat loss, or low power and less heat, more even temperature gradient across the cell).

There is now provided herein a system which provides the additional advantages where a change in a die pattern (as explained below) can readily be made to allow the manufacturer to alter the gas flow plenum channel design, alter the flow pattern, the temperature gradient, the stress across the cell, and the like.

### Example II

### Formation of Anodes and Cathodes from Electrode Scaffolds

Subsequent to sintering and cooling of the monolithic bi-electrode supported cell (BSC) structure 10, the respective electrode scaffolds 14, 16 are treated by solution and thermal means to impart anodic and cathodic catalytic properties to the respective electrode scaffolds. In certain embodiments, these methods can include the capillary uptake of metal salt solutions or sols that will become metal or metal oxide catalysts for the operation of the anode and cathode in the completed cell, and thermal treatment, as needed, to cause chemical reduction of catalytically active metals or metal compounds.

The solution treatment involves the blocking of one electrode scaffold while the other is treated. More specifically, each end of one of the respective electrode scaffolds 14, 16 is masked off to plug the flow microchannels and the gas flow plenum channels 24 with a suitable polymer (for example, such as polypropylene carbonate dissolved in acetone), while the other electrode scaffold is infiltrated with a suitable metal salt. That is, the cathode flow channel 14 is masked off while the anode electrode scaffold 16 is infiltrated with nickel salts and then allowed to become dry at a low temperature before being heat treated at 800° C. to decompose the Ni-salt to NiO which, in subsequent processing, or cell testing is reduced to nickel metal. Then the anode microchannels and gas flow plenum channels 24 are masked off while the cathode electrode scaffold 14 is infiltrated with active cathode materials, such as Sr-doped LaMnO₃ or, more generally, with a mixture of salts of La, Sr, and Mn to create a cathode, which is allowed to dry before being heated to 800° C. in air to form the active air electrode (i.e., cathode), i.e., a perovskite having a general composition of ABO₃ where A=Sr, La, Ca, Ba and B=Co, Fe, Mn, Ni, Cu, Cr, Ga, Mg.

It is to be understood that the electrode scaffolds 14, 16, the electrolyte 12 and the interconnects 19 can be used, prior to sintering, as a repeat unit within a plurality of like unsintered fuel cell repeat units comprising electrode scaffolds, electrolyte layers, and interconnect layers as components of, subsequent to sintering, of a monolithic solid-oxide fuel cell stack framework. The monolithic fuel cell stack framework, subsequent to sintering and to the solution and thermal treatment, thus confers suitable anodic and cathodic properties to the electrode scaffolds, and becomes a complete monolithic solid-oxide fuel cell stack

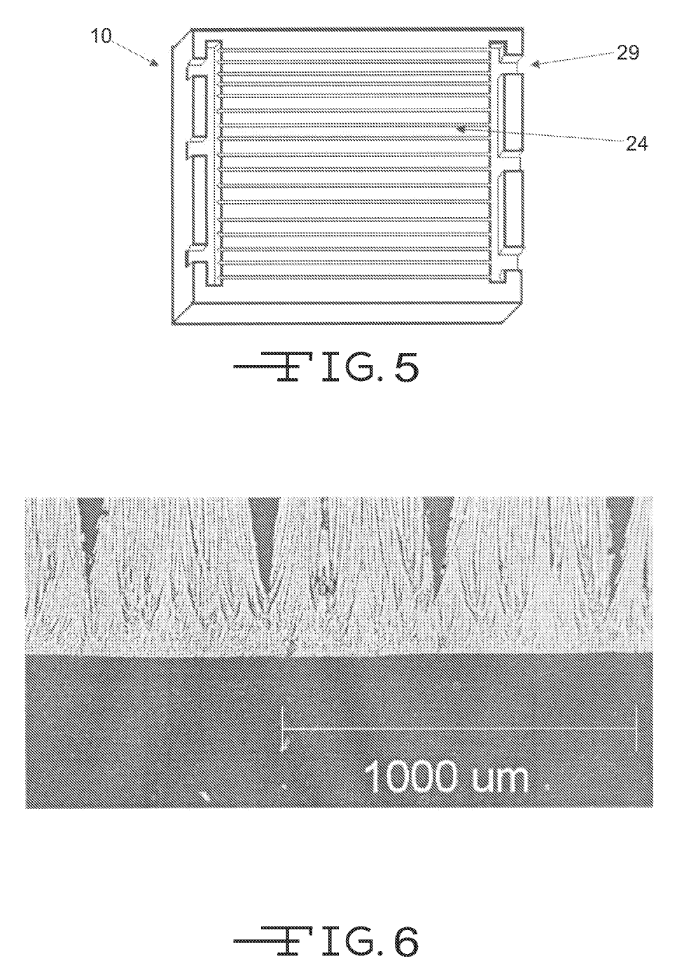

FIG. 6 is an SEM showing gas “V-shaped” flow plenum channels formed on outer edges of electrode scaffolds.

FIG. 7 is an SEM photograph showing a fracture sample, where the smallest pores are at the electrode and the largest pores are at the top of the support scaffold.

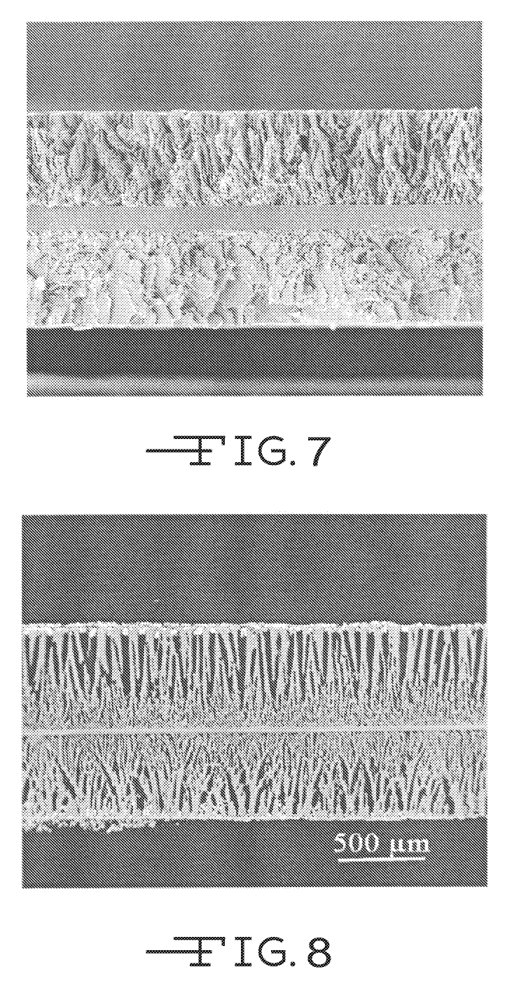

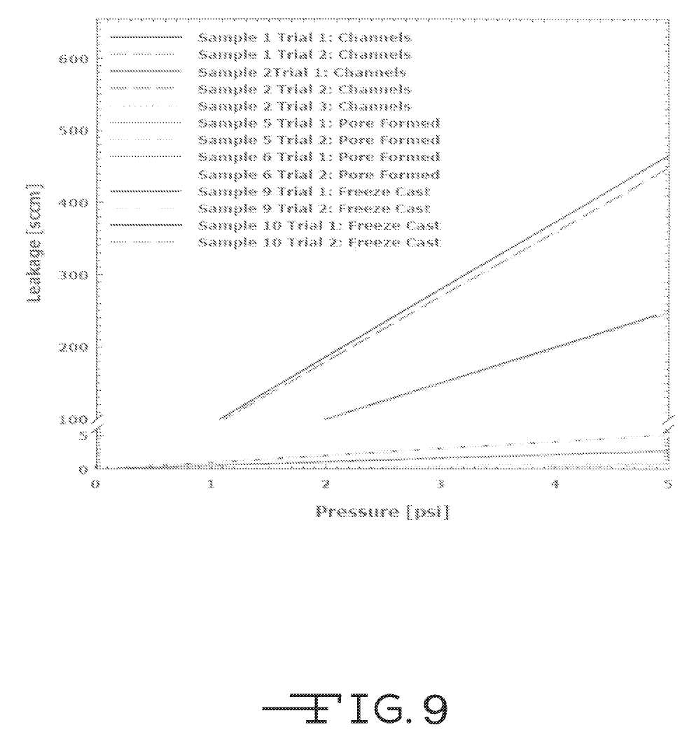

FIG. 8 is an SEM photograph of a trilayer bi-electrode supported cell (BSC) structure showing that the pores have their smaller opening adjacent to the electrolyte layer 12.

FIG. 9 is a graph showing the flow rate for porous YSZ electrode scaffolds with polymer side seals, comparing the flow rates as a function of gas pressure for three types of electrodes; electrodes with porous channels generated with standard pore former materials that burn out during heat treatment; the freeze cast channels; and the freeze cast channels with the addition of V-channels as shown in FIG. 7.

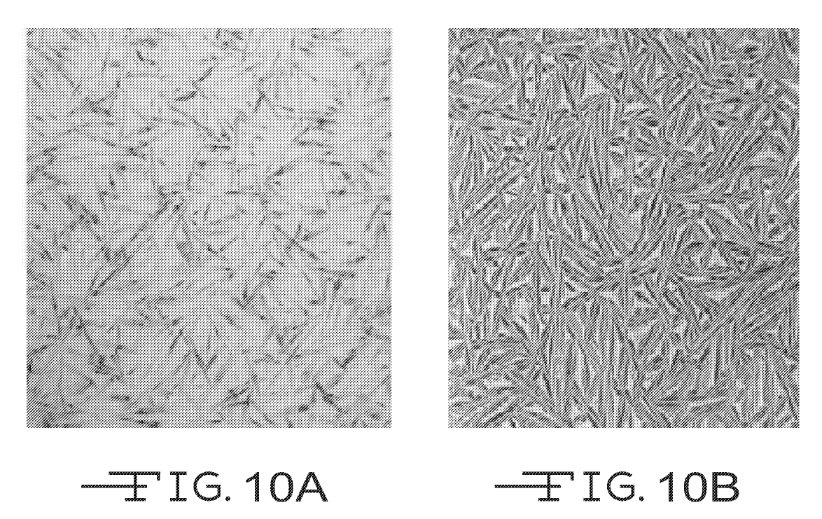

FIGS. 10A and 10B are SEM photographs showing microchannels formed in an electrode scaffold using a non-contact freeze casting process.

Table 1 below compares an anode supported fuel cell (ASC) to a bi-electrode supported fuel cell (BSC) having gas flow plenum channels on the outer surfaces of at least one electrode. The calculations are based on the weight and volume of the cell, i.e., the size, so removal of the metal interconnect in the ASC removes about 75% of the weight and volume.

TABLE 1
Specified Power Calculated using 0.4 W/cm²

| | kW/kg | kW/l |
|---|---|---|
| Anode supported fuel cell (ASC) | 0.28 | 1.3 |
| Bi-electrode supported fuel cell (BSC) | 1.1 | 7.5 |

### Example III

### Forming Gas Flow Plenum Channels

It is to be understood that there are several fabricating methods that are useful to create the gas flow plenum channels 24, most of which involve creating the gas flow plenum channels while the electrodes 14 and/or 16 are soft and in the “green,” or unfired, state.

It is also to be understood that the gas flow channels 24 can be formed in both the cathode “air” electrode scaffold 14 and the anode “fuel” electrode scaffold 16; and that in certain other embodiments, the gas flow channels 24 can be formed in only one of the cathode “air” electrode scaffold 14 or the anode “fuel” electrode scaffold 16.

It is to be understood that the pattern and fabricating methods used to form the gas flow plenum channels 24 can vary, based on the cell design, the intended application, and the stack design. For example, in certain embodiments, the bi-electrode fuel cell (BSC) structure 10 can have a cross-flow design, while, in other embodiments, the bi-electrode fuel cell (BSC) structure 10 can have a co-flow design or counter flow design.

Described in detail herein are fabricating methods which generally fall into two main categories: first, mechanical imprinting, and second; the use of fugitive materials that burn out during the high temperature sintering stage of the stack, creating the open gas flow plenum channels.

### Example III-A

### Fugitive Materials Fabricating Methods

In one aspect, the gas flow plenum channels are created in the electrodes and/or interconnect by the use of fugitive materials. For ease of explanation herein, the fabrication method will be described for forming the gas flow plenum channels on the outer surfaces of the electrode scaffolds and which are disposed to some depth, into the electrode scaffold, as illustrated by the V-channels shown in FIG. 6.

It is to be understood, however, that in certain embodiments, such fabrication methods are also useful to form gas flow plenum channels on the interconnect layers, and that such interconnect fabrication methods are also within the contemplated scope of certain embodiments of the present invention. It is also to be understood, however, in certain embodiments, while additional gas flow channels 26, as shown in FIG. 2, may also be incorporated into the interconnect 19, it is preferable in other embodiments, to have the gas flow plenum channels 24 in the electrodes 14 and/or 16 and for the interconnect 19 to remain a single flat plate.

Non-Contact Freeze Casting Method

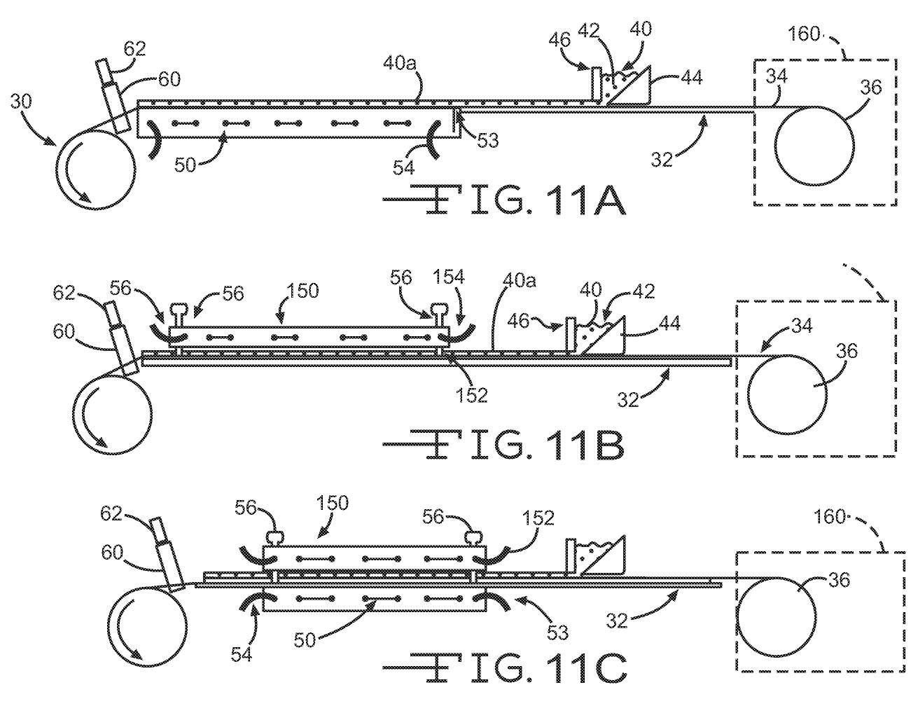

FIGS. 11A, 11B and 11C show schematic illustrations of freeze-tape casting technologies that are different from the earlier co-pending patent Application Pub. No. 2007/0065701A which shows a bottom freeze casting process which requires contact of the material with a freezing bed.

FIGS. 11A, 11B and 11C each show a non-contact freeze-tape casting system 30. It is to be understood that, for ease of explanation herein, similar elements in each of the FIGURES will have the same reference numeral. FIG. 11A shows a “bottom” non-contact freeze-tape casting system 30. FIG. 11B shows a “top” non-contact freeze-tape casting system 30. FIG. 11C shows a “top and bottom” non-contact freeze-tape casting system 30.

In general, the non-contact freeze-tape casting system 30 includes a casting bed 32 across which a carrier material 34 is dispensed from an advancing system 36.

A ceramic slurry material 40 is held in a reservoir 42 defined by a dam 44 and doctor blade 46 which, together, comprise a means for distributing the ceramic slurry material 40 uniformly upon the moveable carrier film material 34. The ceramic slurry material 40 (also called a “slip material”) includes an aqueous or a non-aqueous liquid solvent and ceramic particles which, in certain embodiments, can have a characteristic dimension range of between about 0.1 um and about 5 um and in certain embodiments, between about 0.5 um and about 1.5 um. The ceramic slurry material 40 can have a formulation that also includes, in a water-based system, an acrylic latex binder, which imparts flexibility to the resultant freeze-dried casting. A polymer can also be incorporated into the ceramic slurry material 40 so as to impart flexibility to the resultant cast tape after it is freeze dried. In certain non-limiting examples, when the aqueous carrier solvent is water, a polymer such as acrylic latex emulsions or more traditional polyvinyl alcohol (PVA) or methocel are used. In other non-limiting examples, when the carrier solvent is organic (such as terpineol and/or tertiary butyl alcohol) are used, then the polymer might be polyvinyl butyral or ethyl cellulose.

The doctor blade 46 distributes the ceramic slurry material 40 as a thin cast layer 40a of the ceramic slurry material 40 upon the carrier film material 34 as it progresses across the casting bed 32. It is to be noted that the ceramic slurry material layer 40a, after being formed, becomes the electrode scaffolds 14, 16, as further explained herein.

A first freezing plate 50 is positioned downstream of the reservoir 42. The ceramic slurry material layer 40a, carried by the film material 34, is advanced past the freezing plate 50, whereupon the ceramic slurry material layer 40a material is cooled and “freezes” in a directional way so as to cause the formation of ice (or other) crystals that give rise to the desired graded pore structure within the ceramic slurry material layer 40a. It is to be understood that the “frozen” crystals in the ceramic slurry material layer 40a form the walls of the graded pores 15, 17 found in the electrode scaffolds 14, 16. The pores 15, 17 become larger as the vertical distance from the first freeze plate 50 increases; that is, the crystals grow from an area adjacent to the freezing plate 60 to an area spaced apart from the ceramic slurry material layer 40a. Thus, the freezing of the ceramic slurry material layer 40a causes the directional growth of ice (and/or other solvent) crystals so as to form pores 15, 17 whose characteristic interstitial dimensions decrease in rough proportion to the distance from the freezing plate 50.

The freeze-casting process allows for the forming and controlling of complex pore structures 15, 17 in the electrode scaffolds 14, 16 without the need for thermally fugitive pore formers. Also, in certain embodiments, the freeze-casting system 30 is especially useful for fabrication of the symmetrical bi-electrode supported fuel cell (BSC) structure 10 where the resulting graded pores can be tailored in size and other structural characteristics for fuel and air diffusion within the electrode scaffolds 14, 16. Also, in certain embodiments, the first freeze plate 50 can be positioned and/or moved to a desired distance from the ceramic slurry material layer 40a to control the formation of the pore dimensions. Freeze casting system 30 provides a high degree of structured open porosity in the formed electrodes 14, 16 that is not easily achieved with traditional pore forming technologies.

In certain embodiments, the frozen cast ceramic slurry material layer 40a, while still attached to the carrier film material 34, is quickly removed to a freeze drying chamber 60 where a vacuum 62 causes the ice crystals to evaporate (sublime) so as to leave the graded pores 15,17 in the ceramic slurry material layer 40a. The carrier film material 24 makes the ceramic slurry material layer 40a easier to handle during and after the freeze drying process. In certain embodiments, the carrier material 34 is left attached to the ceramic slurry material layer 40s until after the ceramic slurry material layer 40s is formed/cut to a desired size/dimension. In certain embodiments, the carrier film material 34 is not removed until immediately prior to the application of the electrolyte layer 12 to the electrode(s) 14 and/or 16.

Referring now in particular to FIG. 11A, there is shown a “bottom” non-contact freeze-casting system 30 having the first freezing plate 50 positioned in a spaced apart relation to a bottom surface of the casting bed 32. A gap 52 exists between the freezing plate 50 and the casting bed 32. The first freezing plate 50 can include a system 54 which delivers a suitable coolant through the freezing plate 50. The freezing plate 50 can be movably positioned below the casting bed 32 so that the first freezing plate 50 provides a desired amount and/or rate of heat removal (i.e., freezing) from the ceramic slurry material layer 40a. That is, the first freezing plate 50 can be moved toward and away from the casting bed 34 to create the desired unique microstructures within the electrode scaffold that is formed from the ceramic slurry material layer 40a. In the embodiment shown in FIG. 11A, the ceramic slurry material layer 40a cools/freezes from the bottom-to-top.

The ceramic slurry material freezes in a directional manner so as to cause formation of crystals in the freezing ceramic slurry material, the crystals giving rise to a pore structures within the electrode scaffold. In certain embodiments, a freeze drying chamber 160 can be used where a vacuum causes the crystals to evaporate so as to leave the graded pores within the electrode scaffold.

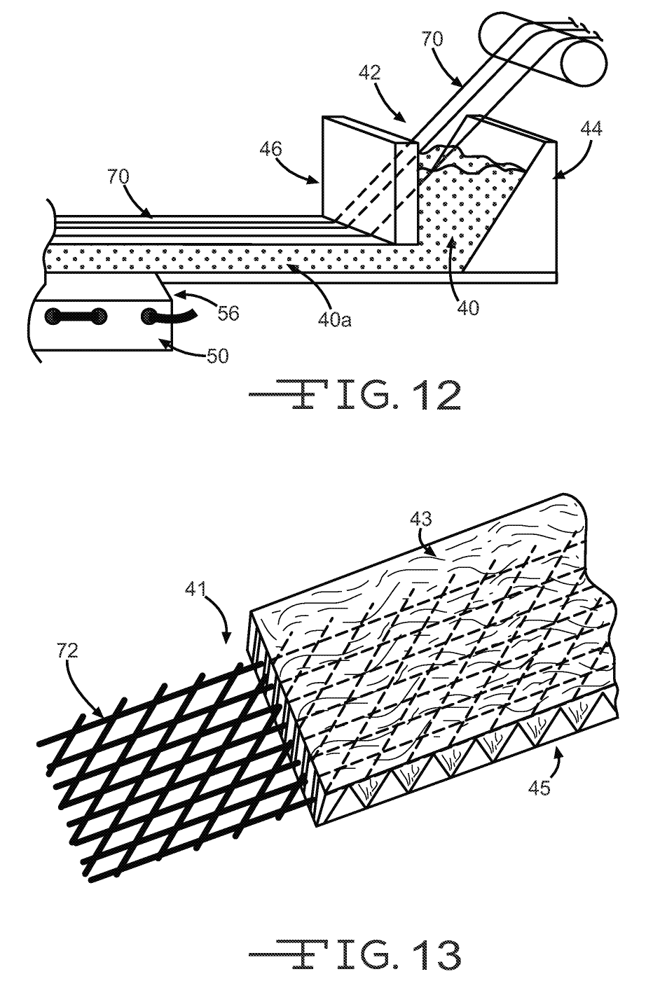

In another non-limiting embodiment, for example, the method for incorporating the gas flow plenum channels using fugitive materials may be achieved by casting the ceramic slurry material onto a mesh or cloth (shown in FIG. 13) and then freezing the ceramic slurry material from the top using the “non-contact” freeze casting method. In such embodiment, the small pore openings are formed at the surface of the ceramic slurry material adjacent to the freezing plate.

Referring now in particular to FIG. 1B, there is shown a “top” non-contact freeze-casting system 30 having a second freezing plate 150 positioned in a spaced-apart relation to a top surface of the casting bed 32. A gap 152 exists between the second freezing plate 150 and the casting bed 32. The second freezing plate 150 can include a system 154 which delivers a suitable coolant through the second freezing plate 150. The second freezing plate 150 can be movably positioned above the casting bed 32 by a height adjustment mechanism 56 so that the second freezing plate 150 provides a desired amount and/or rate of heat removal (i.e., freezing) from the ceramic slurry material layer 40a. That is, the second freezing plate 50 can be moved toward and away from the casting bed 34 to create the desired unique microstructures within the electrode scaffold that is formed from the ceramic slurry material layer 40a. In the embodiment shown in FIG. 11A, the ceramic slurry material layer 40a cools/freezes from the top-to-bottom.

Referring now in particular to FIG. 1 IC, there is shown “top and bottom” non-contact freeze-casting system 30 having the first freezing plate 50 positioned in a spaced-apart relation to a bottom surface of the casting bed 32 where the gap 53 exists between the first freezing plate 50 and the casting bed 32. The first freezing plate 50 can include the system 54 which delivers a suitable coolant through the first freezing plate 50. The freezing first plate 50 can be movably positioned below the casting bed 32 so that the first freezing plate 50 provides a desired amount and/or rate of heat removal (i.e., freezing) from the ceramic slurry material layer 40a. The non-contact freeze-casting system 30 in FIG. 11C also includes the second freezing plate 150 positioned in a spaced-apart relation to a top surface of the casting bed 32 where the gap 152 exists between the second freezing plate 150 and the top of the casting bed 32. The second freezing plate 150 can include the system 154 which delivers a suitable coolant through the second freezing plate 150. The second freezing plate 150 can be movably positioned above the casting bed 32 so that the second freezing plate 150 provides a desired amount and/or rate of heat removal (i.e., freezing) from the ceramic slurry material layer 40a. Thus, one or both of the first freezing plate 50 and/or second freezing plate 150 can be moved toward and away from the casting bed 32 to create the desired unique microstructures within the electrode scaffold that is formed from the ceramic slurry material layer 40a. For example, in the embodiment shown in FIG. 11C, the ceramic slurry material layer 40a cools/freezes from both of its the outer surfaces to an inner portion of the ceramic slurry material layer 40a.

Sintering Method

In another non-limiting embodiment, shown in FIG. 12, gas flow plenum channels are created as follows: Fugitive materials 70 are applied to a top surface of the ceramic slurry material layer 40a. The fugitive materials 70 can be applied in any desired pattern and can be comprised of a suitable fiber mesh material. The fugitive materials 70 are then removed (i.e., burnt out) during a high temperature sintering stage of the stack, leaving open gas flow plenum channels.

Pressing of Patterned Material Method

In another non-limiting embodiment, for example shown in FIG. 13, the method for incorporating the gas flow plenum channels 24 using fugitive materials 70 may be achieved by pressing a nylon mesh 72 or other patterned material into an outer surface 41 of the ceramic slurry material layer 40a such that numerous connected flow path formed by small pores 43 and/or large pores 45 (that become the gas flow plenum channels) are formed on the outer surface of the electrode scaffold.

Application of Fugitive Method

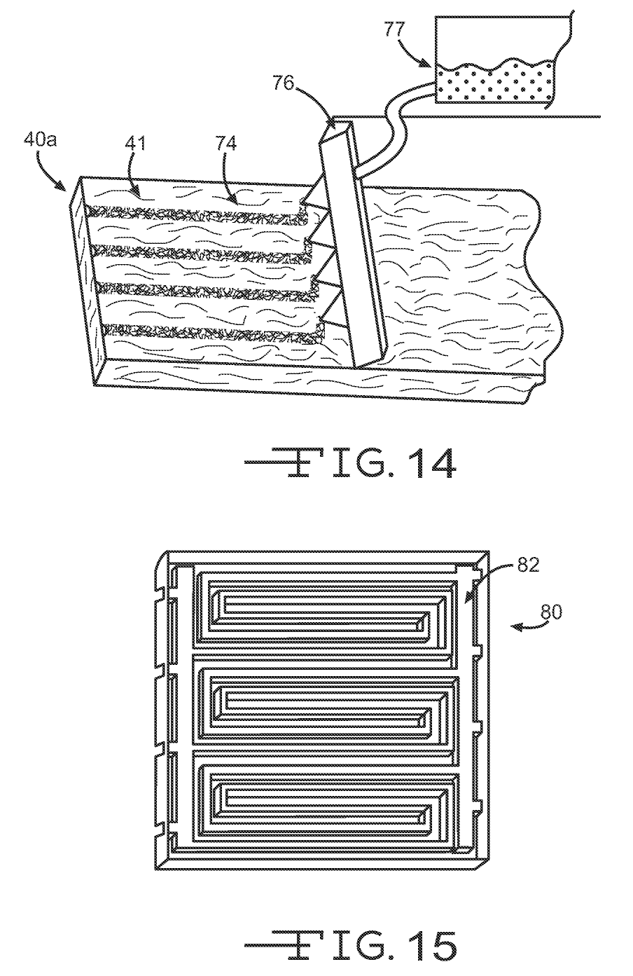

In still another non-limiting embodiment, for example shown in FIG. 14, the method for incorporating the gas flow plenum channels 24 using fugitive materials may be achieved by applying or depositing one or more rows of a fugitive material 74 (for example, graphite) from a dispenser 76 that is connected to a reservoir 77, on the outer surface 41 of the ceramic slurry material layer 40a.

Wax Preforms Method

In still another non-limiting embodiment, shown in FIG. 15, the method for incorporating the gas flow plenum channels 24 using fugitive materials may be achieved by using one or more individual molds 80 as a preform. In one embodiment, the mold 80 can be composed of a wax-type material that has passageways 82. At least the passageways 82 of the mold 80 are filled with the ceramic slurry material. The filled mold 80 is cooled/frozen from the top using the “non-contact” freeze casting system, as described herein. The filled and cooled molds can then be slightly heated to remove the wax mold 80.

### Example III-B

### Imprinting Fabricating Methods

In another aspect, the gas flow plenum channels can be created in the electrodes and/or interconnect by mechanical imprinting one or more gas flow plenum channels onto the electrodes and/or interconnects. For ease of explanation herein, the fabrication method will be described for forming the gas flow plenum channels on the outer surfaces and within the bulk of the electrode scaffolds, as demonstrated by the V-channels in FIG. 6. It is to be understood, however, that in certain embodiments, such fabrication methods are also useful to form gas flow plenum channels on the interconnect layers, and that such interconnect fabrication methods are also within the contemplated scope of certain embodiments of the present invention.

Stamping Method

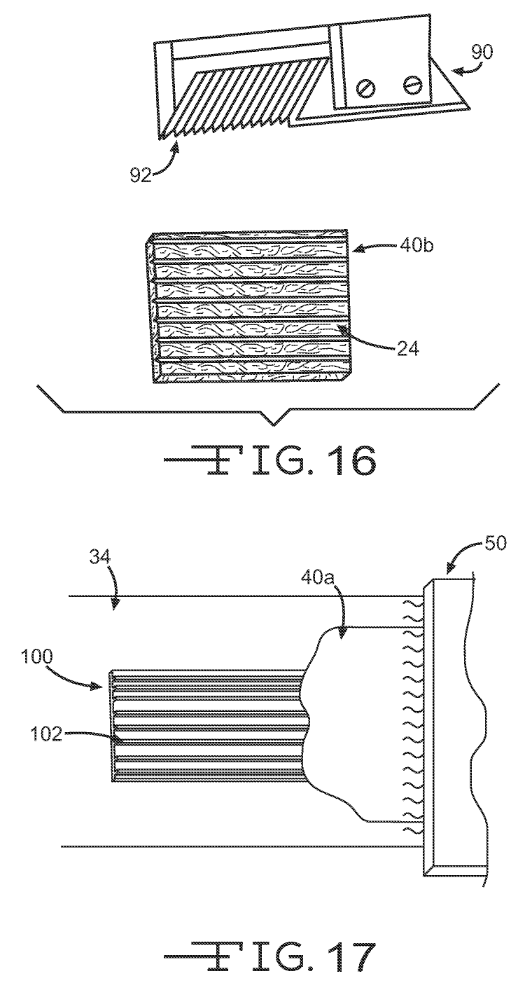

In one non-limiting embodiment, for example, the method for incorporating the gas flow plenum channels 24 using mechanical imprinting may be achieved by using a stamp 90 or die with a plurality of spaced imprint members or blades 92, as shown in FIG. 16. The stamp 90 is pressed into an unsintered, or “green,” electrode scaffold 40b which has been formed from the freeze-casting and freeze-drying of the ceramic slurry material layer. The channels 24 are then present in the electrode scaffold 40b as the “Repeat Unit” and/or stacks are being assembled. While the embodiment shown in FIG. 16 depicts the spaced blades 90 as being uniformly spaced apart, other embodiments can have the blades 92 arranged in different configurations and/or patterns.

Grooved Form Method

In another non-limiting embodiment, for example, as shown in FIG. 17, the method for incorporating the gas flow plenum channels using mechanical imprinting may be achieved by casting the ceramic slurry formulation 40a onto a grooved plate or form 100. The grooved plate 100 can contain a number of troughs 102 that can be filled with the ceramic slurry formulation 40a. The ceramic slurry formulation 40a in the grooved plate 100 is then frozen from the top surface “without contact” by positioning the freezing plate 50 close to a top surface of the ceramic slurry formulation 40a.

Etching Method

In another non-limiting embodiment, for example, as shown in FIG. 18, the method for incorporating the gas flow plenum channels using mechanical imprinting may be achieved by etching the gas flow plenum channels 24 into an electrode scaffold 40c with a laser device 110 where the depth of the gas flow channels 24 in an unsintered, or “green,” electrode scaffold or a sintered electrode is controlled to burn only a fraction of the way into the electrode scaffold 40c. In another non-limiting embodiment, the gas flow channels may be etched using other processes generally known as ablative processes, such as the use of water jet, sand blasting, or plasma etching to form the gas flow channels 24.

Milling Method

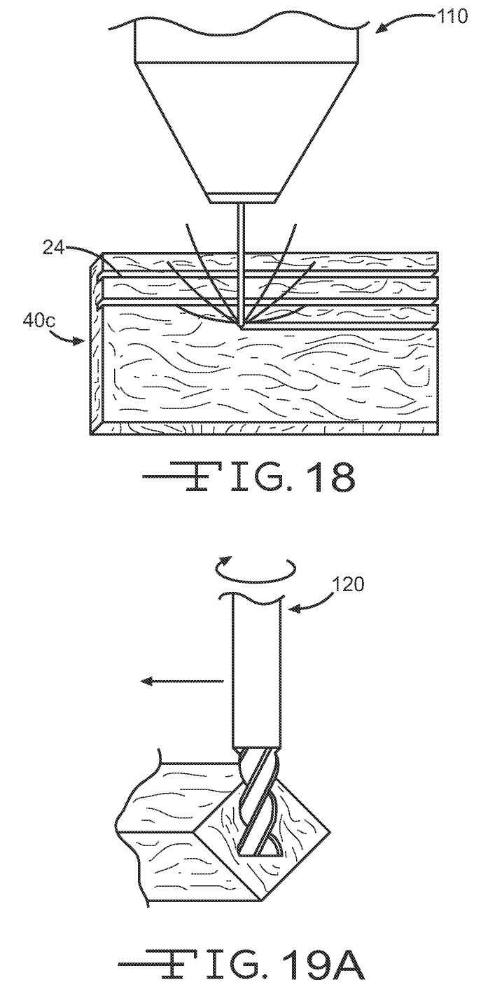

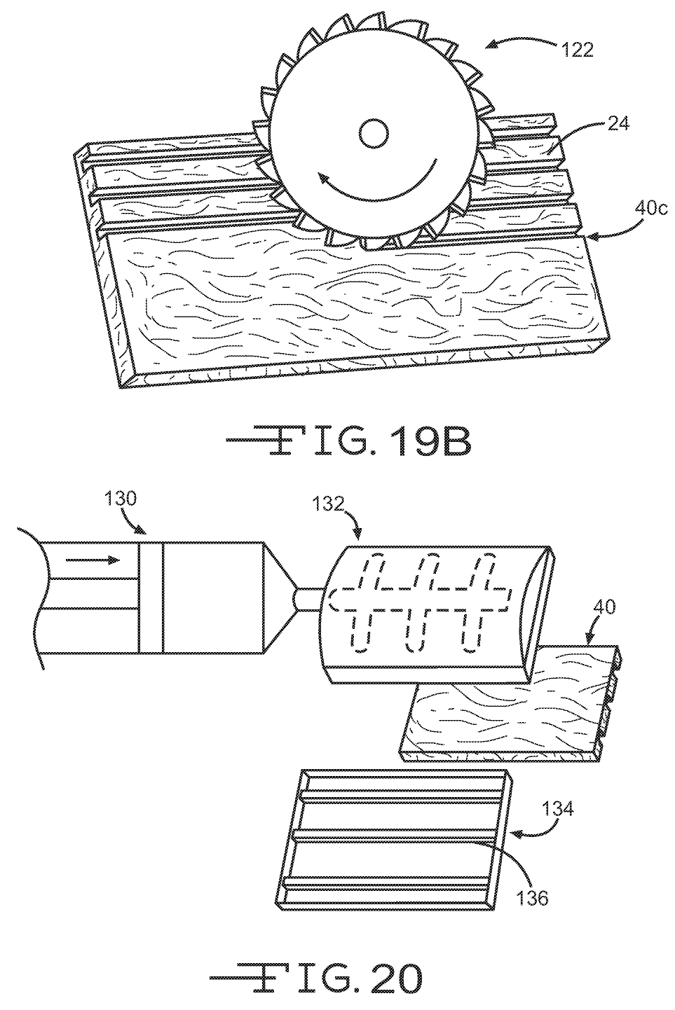

In another non-limiting embodiment, for example, the method for incorporating the gas flow plenum channels 24 may be produced by a type of machining process, as shown in FIG. 19A or 19B. The machining process can be performed using a vertical groove cutting mechanism 120 (FIG. 19A) or horizontal groove cutting mechanism 122 (FIG. 19B).

Extrusion Method

In still another non-limiting embodiment, for example, as shown in FIG. 20, the method for incorporating the gas flow plenum channels using mechanical imprinting may be achieved by extruding the ceramic slurry material formulation 40 from an extrusion mechanism 130 into a freeze cast plate 132 that is positioned near a mold 134 having grooves 136 therein. The ceramic slurry material formulation is then frozen.

Although the present invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A bi-electrode supported solid oxide fuel cell comprising: i) a first electrode scaffold, ii) a second electrode scaffold, and iii) an electrolyte layer disposed between the first and the second electrode scaffolds;
wherein at least one of the first and second electrode scaffolds includes a plurality of gas flow plenum channels.

2. The bi-electrode supported solid oxide fuel cell of claim 1, wherein the first and second electrode scaffold each has an outer surface; and wherein least one of the first and second electrode scaffolds has the plurality of gas flow plenum channels formed in the outer surface thereof.

3. The bi-electrode supported solid oxide fuel cell of claim 1, wherein the plurality of gas flow plenum channels are at least partially within an interior of one or more of first and second electrode scaffolds.

4. The bi-electrode supported solid oxide fuel cell of claim 1, wherein the first electrode scaffold and the second electrode scaffold are porous.

5. The bi-electrode supported solid oxide fuel cell of claim 1, wherein at least one of the first and second electrode scaffolds has a plurality of pores that are oriented generally less perpendicularly with respect to the electrolyte layer,

6. The bi-electrode supported solid oxide fuel cell of claim 5, wherein at least some pores are graded in size such that smallest ends of the pores are adjacent the electrolyte layer.

7. The bi-electrode supported solid oxide fuel cell of claim 2, wherein the gas flow plenum channels are configured to form more than one pattern on the outer surfaces of the electrode scaffold.

8. The bi-electrode supported solid oxide fuel cell of claim 1, wherein the gas flow plenum channels have a depth of between about 10% and about 100% of the thickness of the electrode scaffold.

9. The bi-electrode supported solid oxide fuel cell of claim 1, wherein the first and second electrode scaffolds have essentially the same thickness.

10. The bi-electrode supported solid oxide fuel cell of claim 6, wherein at least some of the graded pores have a small pore end having dimensions between about 0.2 um and about 5 um, and preferably between about 0.2 um and about 1 um, and having a large pore end having dimensions between about 15 um and about 125 um, and preferably of between about 15 um and about 75 um.

11. The bi-electrode supported solid oxide fuel cell of claim 1, wherein the electrode scaffolds are comprised of solid ceramic materials.

12. The bi-electrode supported solid oxide fuel cell of claim 1, wherein the first electrode scaffold and the second electrode scaffold each has an electrically conductive ceramic coating deposited on the outer surface.

13. The bi-electrode supported solid oxide fuel cell of claim 12, wherein the coatings are configured to form interconnects to at least one other bi-electrode supported solid oxide fuel cell in a stack of such cells.

14. The bi-electrode supported solid oxide fuel cell of claim 13, wherein the ceramic interconnects are about 30 microns in thickness.

15. The bi-electrode supported solid oxide fuel cell of claim 1, wherein the electrode scaffolds are comprised of ionic conductor materials.

16. The bi-electrode supported solid oxide fuel cell of claim 15, wherein the ionic conductors are either protons or oxygen ions.

17. The bi-electrode supported solid oxide fuel cell of claim 16, wherein the protonic conductors comprise one or more of: doped barium cerate (BaCeO₃), doped strontium cerate (SrCeO₃), doped barium zirconate (BaZrO₃), strontium zirconate (SrZrO₃), and mixtures thereof.

18. The bi-electrode supported solid oxide fuel cell of claim 16, wherein the oxygen ion conductors is comprised of a fluorite-like crystal structure.

19. The bi-electrode supported solid oxide fuel cell of claim 17, wherein the oxygen ion conductors is comprised of one or more of doped metal oxides.

20. The bi-electrode supported solid oxide fuel cell of claim 17, wherein the doped metal oxides include zirconium, cerium, bismuth, hafnium, thorium, indium or uranium oxides.

21. The bi-electrode supported solid oxide fuel cell of claim 17, wherein the doped metal oxides comprise doped zirconia (ZrO₂) or doped ceria (CeO₂).

22. The bi-electrode supported solid oxide fuel cell of claim 19, wherein the oxide ion conductors comprise one or more of: yttria stabilized zirconia (YSZ or 8YSZ), partially stabilized zirconia (3YSZ), scandia stabilized zirconia (ScSZ), gadolinium doped ceria (GDC), samarium doped ceria (SDC), yttrium doped ceria (YDC), and a perovskite oxide conductor, strontium and magnesium-doped lanthanum gallate, referred to as LSGM (LaSrGaMgO₃).

23. The bi-electrode supported solid oxide fuel cell of claim 1, wherein the electrode scaffolds and the electrolyte layer are comprised of ceramic materials that have essentially the same coefficients of thermal expansion.

24. The bi-electrode supported solid oxide fuel cell of claim 1, wherein the fuel cell further includes electrically conductive interconnect layers that are comprised of the same ceramic materials as the electrode scaffolds and the electrolyte layer.

25. The bi-electrode supported solid oxide fuel cell of claim 1, wherein the gas flow plenum channels are formed in both a cathode or an “oxygen” electrode scaffold and an anode or “fuel” electrode scaffold.

26. The bi-electrode supported solid oxide fuel cell of claim 1, wherein the gas flow plenum channels are formed in only one of a cathode “air” electrode scaffold or an anode “fuel” electrode scaffold.

27. The bi-electrode supported solid oxide fuel cell of claim 1, wherein gas flow plenum channels form a pattern on an outer surface of at least one electrode scaffold.

28. A method for fabricating an electrode scaffold having a plurality of gas flow plenum channels, comprising the step of creating a plurality of gas flow plenum channels in an electrode scaffold while the electrode scaffold is in an unfired state.

29. The method of claim 28, wherein the gas flow plenum channels are formed by removing fugitive materials from the electrode scaffold.

30. The method of claim 29, wherein the fugitive materials are removed during a high temperature sintering stage.

31. The method of claim 28, wherein the gas flow plenum channels are created by applying one or more rows of a fugitive material on at least one outer surface of the electrode scaffold.

32. A method for fabricating an electrode scaffold having a plurality of gas flow plenum channels, comprising the step of casting a ceramic slurry material, and freezing the ceramic slurry material to form the electrode scaffold.

33. The method of claim 32, wherein the freezing forms a complex pore structure in the electrode scaffold without a need for thermally fugitive pore former materials present in the ceramic slurry material.

34. The method of claim 32, including filling a preform with the ceramic slurry material, freezing the ceramic slurry material to form the electrode scaffold, and thereafter removing the perform mold from the formed electrode scaffold.

35. The method of claim 34, wherein the ceramic slurry material freezes in a directional manner so as to cause formation of crystals in the freezing ceramic slurry material, the crystals giving rise to a pore structures within the electrode scaffold.

36. The method of claim 34, wherein the ceramic material is frozen by removing heat from a top surface of the ceramic slurry material such that the ceramic slurry material freezes in a top-to-bottom directional manner.

37. The method of claim 34, wherein the ceramic material is frozen by removing heat from a bottom surface of the ceramic slurry material such that the ceramic slurry material freezes in a bottom-to-top directional manner.

38. The method of claim 34, wherein the ceramic material is frozen by removing heat from a top surface and a bottom surface of the ceramic slurry material such that the ceramic slurry material freezes in an outside-to-inside directional manner.

39. The method of claim 28, wherein gas flow plenum channels are formed using a mechanical imprinting process.

40. The method of claim 39, wherein the gas flow plenum channels are formed by pressing a patterned material into an outer surface of the electrode scaffold.

41. The method of claim 39, including pressing a stamp or die with a plurality of spaced blades into an outer surface of the electrode scaffold, freeze casting to form the electrode scaffold, and freeze drying the formed electrode scaffold.

42. The method of claim 39, including casting a ceramic slurry material onto a grooved plate; non-contact freezing the ceramic slurry material to form the electrode scaffold, and thereafter, freeze drying the formed electrode scaffold on the grooved plate.

43. The method of claim 28, wherein the gas flow plenum channels are created by etching a plurality of gas flow plenum channels onto an outer surface of the electrode scaffold.

44. The method claim 28, wherein the gas flow plenum channels are created by machining a plurality of gas flow plenum channels onto an outer surface of the electrode scaffold, either in a vertical or a horizontal direction

45. The method of claim 28, further including providing interconnect layers adjacent to the electrode scaffold and forming gas flow plenum channels on the interconnect layer prior to positioning the interconnect layers adjacent to the electrode scaffold.

46. A non-contact freeze casting system wherein a ceramic slurry material freezes in a directional manner so as to cause formation of crystals in the freezing ceramic slurry material, the crystals giving rise to a pore structures within the electrode scaffold, the system comprising:
a casting bed across which a carrier material is dispensed;
a reservoir configured for dispensing a ceramic slurry material onto the carrier material;
at least one freezing plate positioned in a spaced apart relationship to the casting bed; and
a system for advancing the ceramic slurry material and film past the freezing plate.

47. The system of claim 46, further including a freeze drying chamber wherein a vacuum causes the crystals to evaporate so as to leave the graded pores within the electrode scaffold.
